(19) United States
(12) Patent Application Publication
(10) Pub. No.: US 2024/0311620 A1
(43) Pub. Date: Sep. 19, 2024

(54) NEURAL NETWORK COMPUTING METHOD AND NEURAL NETWORK COMPUTING DEVICE

(71) Applicant: MACRONIX INTERNATIONAL CO., LTD., Hsinchu (TW)

(72) Inventors: Yu-Yu LIN, New Taipei City (TW); Feng-Min LEE, Hsinchu City (TW)

(21) Appl. No.: 18/185,751

(22) Filed: Mar. 17, 2023

(51) Int. Cl. G06N 3/0464

(52) U.S. Cl. CPC G06N 3/0464

(57) ABSTRACT

A neural network computing method and a neural network computing device are provided. The neural network computing method includes the following steps. At least one chosen layer is decided. A plurality of front layers previous to the chosen layer are decided. A selected element is selected from a plurality of chosen elements in the chosen layer. A front computing data group related to the selected element is defined. The front computing data group is composed of only part of a plurality of front elements in the front layers. The selected element is computed according to the at least one front computing data group.

### TECHNICAL FIELD

The disclosure relates in general to a computing method and a computing device, and more particularly to a neural network computing method and a neural network computing device.

### BACKGROUND

For the neural network (NN) computation, the size of the intermediate data reflects the required memory size. The larger or enough capacity of the working memory (e.g., SRAM, DRAM, register) would improve the efficiency of the NN calculation. However, the larger working capacity consumes more die area and increases the cost.

In the ordinary computation sequence of the neural network model, the data (input and weight values of each layer) should be calculated layer by layer. The whole intermediate data of a certain layer would be calculated and stored to the working memory. The required working memory capacity is quite large.

### SUMMARY

The disclosure is directed to a neural network computing method and a neural network computing device. The data in the neural network could be computed via front computing data, and only part of the front elements in any one of the front layers are needed to be stored. Therefore, the memory usage is greatly reduced, and the memory area as well as the cost can be decreased.

According to one embodiment, a neural network computing method is provided. The neural network computing method includes the following steps. At least one chosen layer is decided. A plurality of front layers previous to the chosen layer are decided. A selected element is selected from a plurality of chosen elements in the chosen layer. A front computing data group related to the selected element is defined. The front computing data group is composed of only part of a plurality of front elements in the front layers. The selected element is computed according to the at least one front computing data group.

According to another embodiment, a neural network computing device is provided. The neural network computing device includes a deciding unit, a selecting unit, a defining unit and a computing unit. The deciding unit is configured to decide at least one chosen layer and decide a plurality of front layers previous to the chosen layer. The selecting unit is configured to select a selected element from a plurality of chosen elements in the chosen layer. The defining unit is configured to define a front computing data group related to the selected element. The front computing data group is composed of only part of a plurality of front elements in the front layers. The computing unit is configured to compute the selected element according to the at least one front computing data group.

According to an alternative embodiment, a neural network computing method is provided. The neural network computing method includes the following steps. At least one chosen layer is decided. A plurality of front layers previous to the chosen layer are decided. More than one selected elements from a plurality of chosen elements in the chosen layer are selected. More than one front computing data groups related to the selected elements are defined. Each of the front computing data groups is composed of only part of a plurality of front elements in the front layers. The selected elements are computed according to the more than one front computing data groups.

### BRIEF DESCRIPTION OF THE DRAWINGS

FIGS. 1A to 1C illustrate how the neural network is calculated via a “layer-by-layer” approach.

FIG. 2 illustrates how the neural network is calculated via a “multi-layer jump” approach.

FIG. 3 illustrates a neural network computing method according to one embodiment.

FIG. 4 illustrates front computing data of one chosen element.

FIG. 5 illustrates the front computing data in one dimension.

FIG. 6 show a neural network computing device according to one embodiment.

FIG. 7 shows a flowchart of a neural network computing method according to one embodiment.

FIG. 8 shows a flowchart of a neural network computing method according to another embodiment.

FIG. 9 illustrates front computing data of more than one chosen elements.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

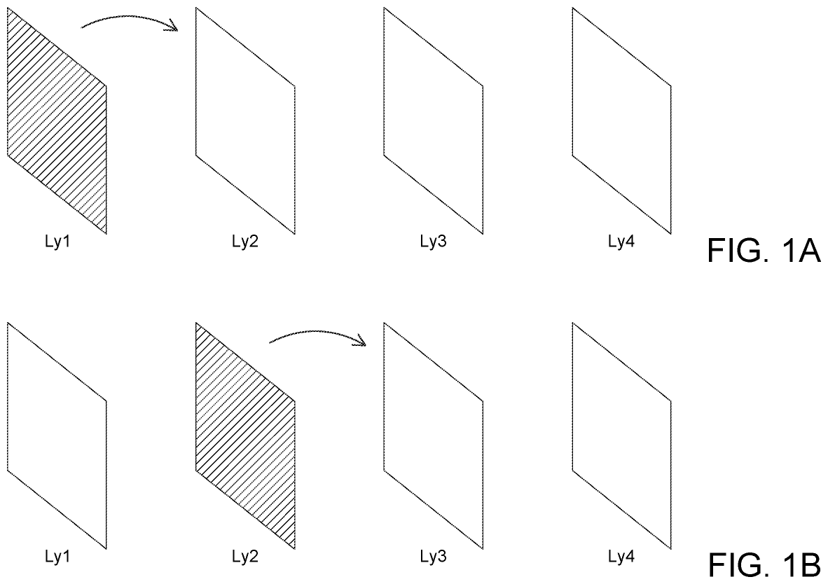

Please refer to FIGS. 1A to 1C, which illustrate how the neural network is calculated via a “layer-by-layer” approach. As shown in FIG. 1A, the neural network has, for example, multiple convolutional layers Ly1 to Ly4. In the “layer by layer” approach, all elements on the convolutional layer Ly1 need to be stored (the slash indicates the part that needs to be stored) before any element in the convolutional layer Ly2 is calculated. After all the elements on the convolutional layer Ly2 are calculated, the process will enters the calculation of FIG. 1B.

In FIG. 1B, all elements in the convolutional layer Ly2 need to be stored (the slash indicates the part that needs to be stored) before any element in the convolutional layer Ly3 is calculated. After all the elements on the convolutional layer Ly3 are calculated, the process will enter the calculation of FIG. 1C.

In FIG. 1C, all elements in the convolutional layer Ly3 need to be stored (the slash indicates the part that needs to be stored) before any element in the convolutional layer Ly4 is calculated.

As mentioned above, in the “layer by layer” approach, it is necessary to store the entire convolutional layer Ly1, Ly2, Ly3, or Ly4 each time, consuming a large amount of memory capacity.

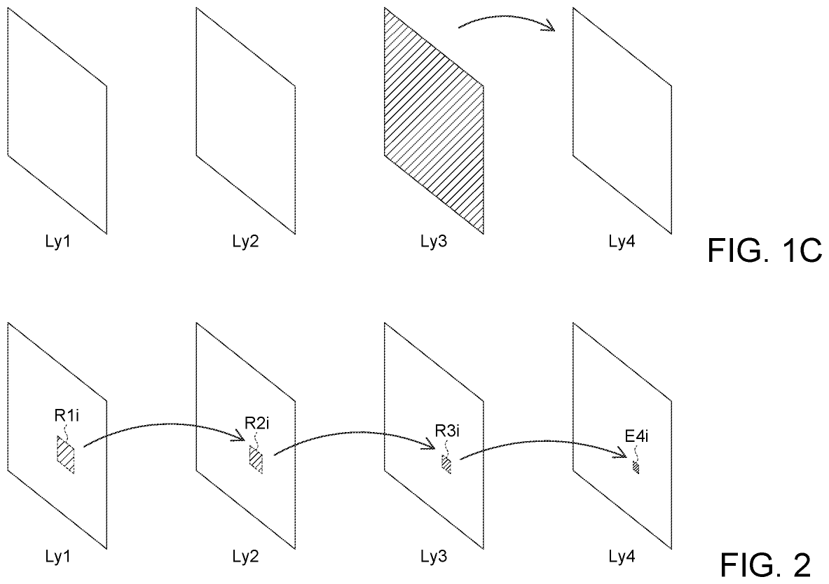

Please further refer to FIG. 2, which illustrates how the neural network is calculated via a “multi-layer jump” approach. As shown in FIG. 2, the elements in the range R1i in the convolutional layer Ly1 can be used to calculate all of the elements in the range R2i in the convolutional layer Ly2. The elements in the range R2i in the convolutional layer Ly2 can be used to calculate all of the elements in the range R3i in the convolutional layer Ly3. The elements in the range R3i in the convolutional layer Ly3 can be used to calculate all of the elements in the range R4i in the convolutional layer Ly4. That is to say, a certain element E4i in the convolutional layer Ly4 can be calculated by the range R1i of the convolutional layer Ly1, the range R2i of the convolutional layer Ly2, and the range R3i of the convolutional layer Ly3. After each element in the convolutional layer Ly4 is calculated one by one, the calculation of the convolutional layer Ly4 can also be completed. Therefore, using this “multi-layer jump” approach, only the range R1i of the convolutional layer Ly1, the range R2i of the convolutional layer Ly2, and the range R3i of the convolutional layer Ly3 need to be stored for calculating an element of E4i in the convolutional layer Ly4.

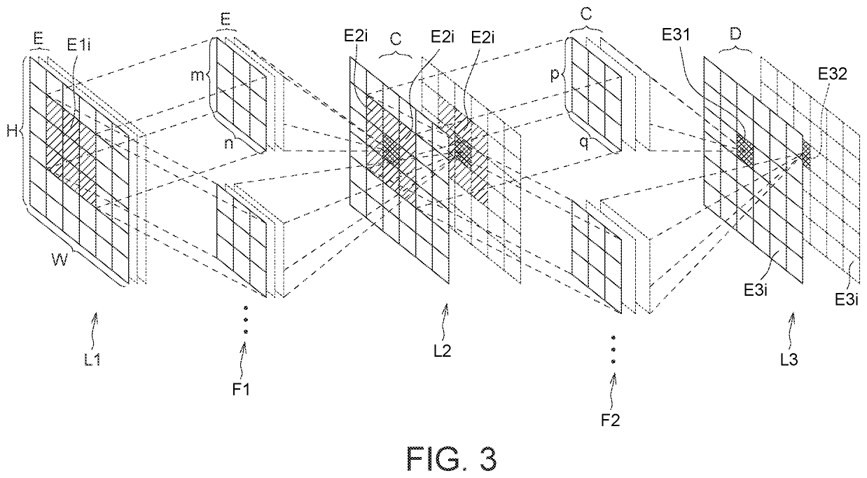

Please refer to FIG. 3, which illustrates a neural network computing method according to one embodiment. In the present embodiment, the neural network is not computed via “layer-by-layer” approach. Instead, via the “multi-layer jump” approach, several front layers L1, L2 previous to one chosen layer L3 are used to compute each of a plurality of chosen element E3i in the chosen layer L3.

For example, one selected element E31 is selected from the chosen elements E3i in the chosen layer L3. Due to the size of the filter layer F2, it needs to pick up p*q*C front elements E2i in the front layer L2. Due to the size of the filter layer F1, it needs to pick up (p+m−1)*(q+n−1)*E front elements E1i in front layer L1.

Further, one selected element E32 is selected from the chosen elements E3i in the chosen layer L3. Due to the size of the filter layer F2, it needs to pick up p*q*C front elements E2i in the front layer L2. Due to the size of the filter layer F1, it needs to pick up (p+m−1)*(q+n−1)*E front elements E1i in front layer L1.

That is to say, to compute each of the chosen elements E3i in the chosen layer L3, only (p+m−1)*(q+n−1)*E front elements E1i are needed to be stored. On the contrary, if the front layer L1 and the front layer L2 are computed layer by layer, H*W*E front elements E1i are needed to be stored. It is clear that (p+m−1)*(q+n−1)*E is much less than H*W*E. Comparing to the computation in way of layer by layer, the usage of the memory in the present embodiment using the “multi-layer jump” approach is greatly reduced.

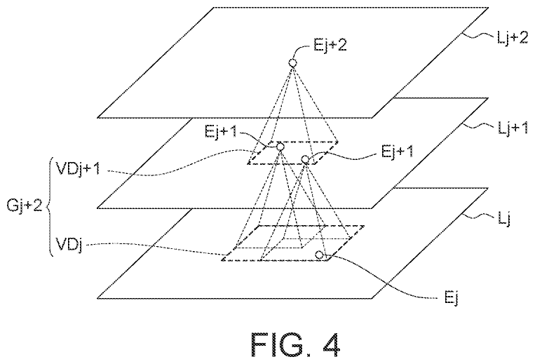

Please refer to FIG. 4, which illustrates front computing data of one chosen element. For a chosen element Ej+2 in one chosen layer Lj+2, that might find some related front elements Ej+i in the previous front layer Lj+1 due to the filter and convolution condition. The required front elements Ej+1 in the previous front layer Lj+1 are defined as the front computing data VDj+1 of the chosen element Ej+2.

All front computing data VDj+1, VDj in the front layers Lj+1, Lj in front of the chosen element Ej+2 are defined as the front computing data group Gj+2.

For the more layer difference, the front computing data usually becomes wider for a certain chosen element. For example, the front computing data VDj has larger size than the front computing data VDj+1. In one embodiment, the number of the front layers could be more than two.

The size of the front computing data depends on the neural network configuration, e.g., the filter size, stride step size, layer depth, pooling operation, and layer number, etc.

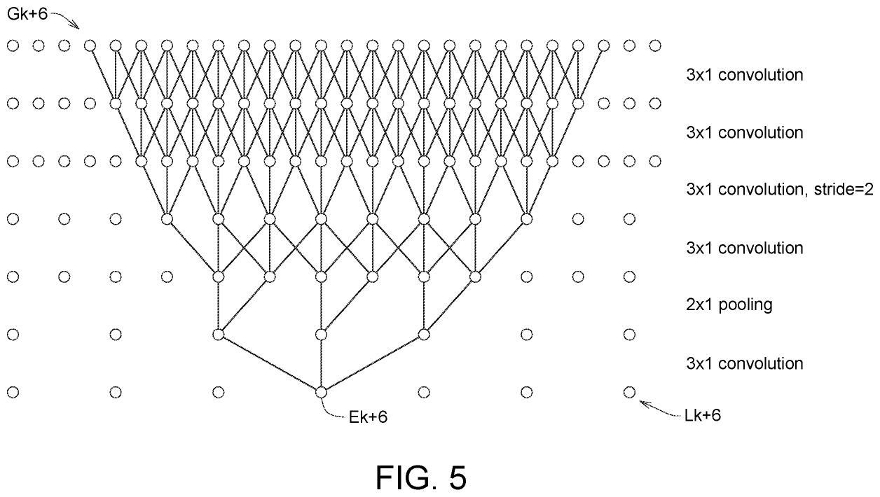

Please refer to FIG. 5, which illustrates the front computing data in one dimension. For a chosen element Ek+6 in one chosen layer Lk+6, the chosen element Ek+6 might be computed through two 3×1 convolutions, one 3×1 convolution with stride at 2, one 3×1 convolution, one 2×1 polling, and one 3×1 convolution. The related front computing data group Gk+6 can be found through the neural network structure. The front computing data group Gk+6 of different chosen elements Ek+6 can be calculated in parallel, which might improve the computation performance.

Please refer to table I, which uses the neural network VGG16 as an example. If the data is computed layer by layer, the maximum required intermediate data size is 3136K for the ordinary VGG16 model. If the data is computed via front computing data, for 1×1×256 chosen elements after the “Pooling 3” layer, the required intermediate data size is 396K and the required vision data size is 110.25K. The total data size is 506.25K (396K+110.25K) and it results about 0.16× of reduction of the memory usage.

TABLE I

| | Filter or | Intermediate | Front computing |
|---|---|---|---|
| Layer | Pooling size | data size | data size |
| Input | | 224 × 224 × 3 = 147K | |
| Conv1_1 + ReLU | 3 × 3 × 3 × 64 | 224 × 224 × 64 = 3136K | 44 × 44 × 3 = 5.67K |
| Conv1_2 + ReLU | 3 × 3 × 64 × 64 | 224 × 224 × 64 = 3136K | 42 × 42 × 64 = 110.25K |
| Pooling 1 | 2 × 2 | 112 × 112 × 64 = 784K | 40 × 40 × 64 = 100K |
| Conv2_1 + ReLU | 3 × 3 × 64 × 128 | 112 × 112 × 128 = 1568K | 20 × 20 × 64 = 25K |
| Conv2_2 + ReLU | 3 × 3 × 128 × 128 | 112 × 112 × 128 = 1568K | 18 × 18 × 128 = 40.5K |
| Pooling 2 | 2 × 2 | 56 × 56 × 128 = 392K | 16 × 16 × 128 = 32K |
| Conv3_1 + ReLU | 3 × 3 × 128 × 256 | 56 × 56 × 256 = 784K | 8 × 8 × 128 = 8K |
| Conv3_2 + ReLU | 3 × 3 × 256 × 256 | 56 × 56 × 256 = 784K | 6 × 6 × 256 = 9K |
| Conv3_3 + ReLU | 3 × 3 × 256 × 256 | 56 × 56 × 256 = 784K | 4 × 4 × 256 = 4K |
| Pooling 3 | 2 × 2 | 28 × 28 × 256 = 196K | 2 × 2 × 256 = 1K |
| Conv4_1 + ReLU | 3 × 3 × 256 × 512 | 28 × 28 × 512 = 396K | |
| Conv4_2 + ReLU | 3 × 3 × 512 × 512 | 28 × 28 × 512 = 396K | |
| Conv4_3 + ReLU | 3 × 3 × 512 × 512 | 28 × 28 × 512 = 396K | |
| Pooling 4 | 2 × 2 | 14 × 14 × 512 = 98K | |
| Conv5_1 + ReLU | 3 × 3 × 512 × 512 | 14 × 14 × 512 = 98K | |
| Conv5_2 + ReLU | 3 × 3 × 512 × 512 | 14 × 14 × 512 = 98K | |
| Conv5_3 + ReLU | 3 × 3 × 512 × 512 | 14 × 14 × 512 = 98K | |
| Pooling 5 | 2 × 2 | 7 × 7 × 512 = 24.5K | |
| FC + ReLU + | | 4096 | |
| Drop | | | |
| FC + ReLU + | | 4096 | |
| Drop | | | |
| FC + Softmax | | 1000 | |

Please refer to table II, which uses the neural network ResNET18 as an example. If the data is computed layer by layer, the maximum required intermediate data size is 784K for the ordinary ResNET18 model. If the data is computed via front computing data, for 1×1×256 chosen elements after the “Layer 10” layer, the required intermediate data size is 49K and the required front computing data size is 49K. The total data size is 98K (48K+48K) and it results about 0.125× of reduction of the memory usage.

TABLE II

| | | | | Front computing |
|---|---|---|---|---|
| | | | | data size for the |
| | | Filter or | Intermediate | chosen element in |
| | Layer | Pooling size | data size | Layer10 |
| Layer1 | 7 × 7, Conv, 64, /2 | 7 × 7 × 3 × 64, stride = 2 | 112 × 112 × 64 = 784K | |
| | Max pool, /2 | 3 × 3, stride = 2 | 56 × 56 × 64 = 196K | 56 × 56 × 3 = 9.1875K |
| Layer2 | 3 × 3, Conv, 64 | 3 × 3 × 64 × 64 | 56 × 56 × 64 = 196K | 28 × 28 × 64 = 49K |
| Layer3 | 3 × 3, Conv, 64 | 3 × 3 × 64 × 64 | 56 × 56 × 64 = 196K | 26 × 26 × 64 = 42.25K |
| Layer4 | 3 × 3, Conv, 64 | 3 × 3 × 64 × 64 | 56 × 56 × 64 = 196K | 24 × 24 × 64 = 36K |
| Layer5 | 3 × 3, Conv, 64 | 3 × 3 × 64 × 64 | 56 × 56 × 64 = 196K | 22 × 22 × 64 = 30.25K |
| Layer6 | 3 × 3, Conv, 128, /2 | 3 × 3 × 64 × 128, stride = 2 | 28 × 28 × 128 = 98K | 20 × 20 × 64 = 25K |
| Layer7 | 3 × 3, Conv, 128 | 3 × 3 × 128 × 128 | 28 × 28 × 128 = 98K | 9 × 9 × 64 = 5.0625K |
| Layer8 | 3 × 3, Conv, 128 | 3 × 3 × 128 × 128 | 28 × 28 × 128 = 98K | 7 × 7 × 128 = 6.125K |
| Layer9 | 3 × 3, Conv, 128 | 3 × 3 × 128 × 128 | 28 × 28 × 128 = 98K | 5 × 5 × 128 = 3.125K |
| Layer10 | 3 × 3, Conv, 256, /2 | 3 × 3 × 128 × 256, stride = 2 | 14 × 14 × 256 = 49K | 3 × 3 × 1 × 128 = 1.125K |
| Layer11 | 3 × 3, Conv, 256 | 3 × 3 × 256 × 256 | 14 × 14 × 256 = 49K | |
| Layer12 | 3 × 3, Conv, 256 | 3 × 3 × 256 × 256 | 14 × 14 × 256 = 49K | |
| Layer13 | 3 × 3, Conv, 256 | 3 × 3 × 256 × 256 | 14 × 14 × 256 = 49K | |
| Layer14 | 3 × 3, Conv, 512, /2 | 3 × 3 × 256 × 512, stride = 2 | 7 × 7 × 512 = 24.5K | |
| Layer15 | 3 × 3, Conv, 512 | 3 × 3 × 512 × 512 | 7 × 7 × 512 = 24.5K | |
| Layer16 | 3 × 3, Conv, 512 | 3 × 3 × 512 × 512 | 7 × 7 × 512 = 24.5K | |
| Layer17 | 3 × 3, Conv, 512 | 3 × 3 × 512 × 512 | 7 × 7 × 512 = 24.5K | |
| | Average pool | | 1 × 1 × 512 = 0.5K | |
| Layer18 | FC | | 1000 | |

Please refer to table III, which uses the neural network ResNET18 as another example. If the data is computed layer by layer, the maximum required intermediate data size is 784K for the ordinary ResNET18 model. If the data is computed via front computing data, for 1×1×128 chosen elements after the “Layer 6” layer, the required intermediate data size is 98K and the required front computing data size is 7.563K. The total data size is 105.563K (98K+7.563K) and it results about 0.135× of reduction of the memory usage.

TABLE III

| | | | | Front computing |
|---|---|---|---|---|
| | | | | data size for the |
| | | Filter or | Intermediate | chosen element in |
| | Layer | Pooling size | data size | Layer6 |
| Layer1 | 7 × 7, Conv, 64, /2 | 7 × 7 × 3 × 64, stride = 2 | 112 × 112 × 64 = 784K | |
| | Max pool, /2 | 3 × 3, stride = 2 | 56 × 56 × 64 = 196K | 22 × 22 × 3 = 1452 |
| Layer2 | 3 × 3, Conv, 64 | 3 × 3 × 64 × 64 | 56 × 56 × 64 = 196K | 11 × 11 × 64 = 7744 |
| | | | | (7.563K) |
| Layer3 | 3 × 3, Conv, 64 | 3 × 3 × 64 × 64 | 56 × 56 × 64 = 196K | 9 × 9 × 64 = 5184 |
| Layer4 | 3 × 3, Conv, 64 | 3 × 3 × 64 × 64 | 56 × 56 × 64 = 196K | 7 × 7 × 64 = 3136 |
| Layer5 | 3 × 3, Conv, 64 | 3 × 3 × 64 × 64 | 56 × 56 × 64 = 196K | 5 × 5 × 64 = 1600 |
| Layer6 | 3 × 3, Conv, 128, /2 | 3 × 3 × 64 × 128, stride = 2 | 28 × 28 × 128 = 98K | 3 × 3 × 64 = 576 |
| Layer7 | 3 × 3, Conv, 128 | 3 × 3 × 128 × 128 | 28 × 28 × 128 = 98K | |
| Layer8 | 3 × 3, Conv, 128 | 3 × 3 × 128 × 128 | 28 × 28 × 128 = 98K | |
| Layer9 | 3 × 3, Conv, 128 | 3 × 3 × 128 × 128 | 28 × 28 × 128 = 98K | |
| Layer10 | 3 × 3, Conv, 256, /2 | 3 × 3 × 128 × 256, stride = 2 | 14 × 14 × 256 = 49K | |
| Layer11 | 3 × 3, Conv, 256 | 3 × 3 × 256 × 256 | 14 × 14 × 256 = 49K | |
| Layer12 | 3 × 3, Conv, 256 | 3 × 3 × 256 × 256 | 14 × 14 × 256 = 49K | |
| Layer13 | 3 × 3, Conv, 256 | 3 × 3 × 256 × 256 | 14 × 14 × 256 = 49K | |
| Layer14 | 3 × 3, Conv, 512, /2 | 3 × 3 × 256 × 512, stride = 2 | 7 × 7 × 512 = 24.5K | |
| Layer15 | 3 × 3, Conv, 512 | 3 × 3 × 512 × 512 | 7 × 7 × 512 = 24.5K | |
| Layer16 | 3 × 3, Conv, 512 | 3 × 3 × 512 × 512 | 7 × 7 × 512 = 24.5K | |
| Layer17 | 3 × 3, Conv, 512 | 3 × 3 × 512 × 512 | 7 × 7 × 512 = 24.5K | |
| | Average pool | | 1 × 1 × 512 = 0.5K | |
| Layer18 | FC | | 1000 | |

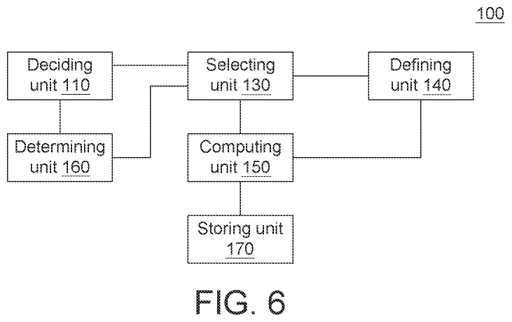

According to the examples shown above, the neural network computed via front computing data could result large reduction of the memory usage. Please refer to FIG. 6, which show a neural network computing device 100 according to one embodiment. For computing the data in the neural network via front computing data, the neural network computing device 100 is provided. The neural network computing device 100 is, for example, a computer, a chip, a circuit, a circuit board, program codes or a storage device storing program codes. The neural network computing device 100 includes a deciding unit 110, a selecting unit 130, a defining unit 140, a computing unit 150, a determining unit 160 and a storing unit 170. The storing unit 170 is used for storing data. For example, the storing unit 170 could be a memory, a disk or a storage cloud. The deciding unit 110, the selecting unit 130, the defining unit 140, the computing unit 150 and the determining unit 160 are used to perform various computer operations. For example, the deciding unit 110, the selecting unit 130, the defining unit 140, the computing unit 150 and the determining unit 160 could be a chip, a circuit, a circuit board, program codes or a storage device storing program codes. Through those components, the data in the neural network could be computed via front computing data. The operations of those components are illustrated through a flowchart as below.

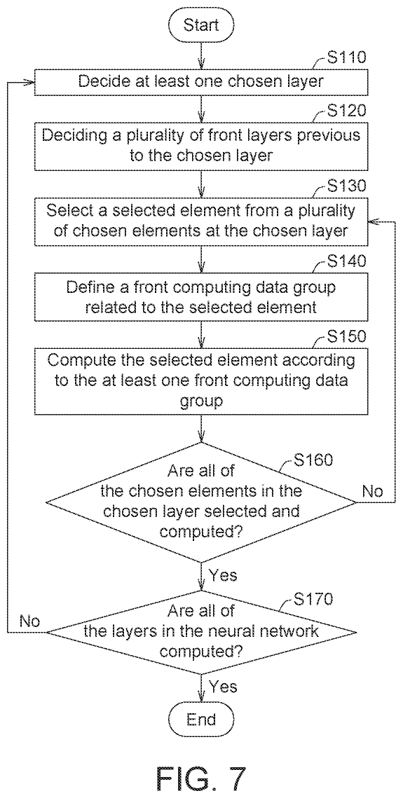

Please refer to FIG. 7, which shows a flowchart of a neural network computing method according to one embodiment. The neural network computing method is used for a Visual Geometry Group (VGG) model, a residual network (ResNET) model, or a Binary neural network model. In step S110, as shown in FIG. 3, the deciding unit 110 decides at least one chosen layer (e.g., the chosen layer L3). In this step, the deciding unit 110 may decide the chosen layer according to the required front computing data size. To minimum the required front computing data size, more than one chosen layers may be decided. After one chosen layer is computed, the next one chosen layer is computed.

Then, in step S120, as shown in FIG. 3, the deciding unit 110 decides a plurality of front layers (e.g., the front layers L1, L2) previous to the chosen layer (e.g., the chosen layer L3). In this step, the layers between the previous chosen layer (or the input) and this chosen layer are decided as the front layers.

Next, in step S130, as shown in FIG. 3, the selecting unit 130 selects a selected element (e.g., the selected element E31), from a plurality of chosen elements (e.g., the chosen elements E3i) in the chosen layer (e.g., the chosen layer L3). In this step, all of the chosen elements E3j in the chosen layer L3 are selected one by one. After one selected element (e.g., the selected element E31) is computed, then another selected element (e.g., the selected element E32) is selected.

Afterwards, in step S140, as shown in FIG. 4, the defining unit 140 defines a front computing data group (e.g., the front computing data group Gj+2) related to the selected element (e.g., the selected element Ej+2). The front computing data group Gj+2 is composed of only part of the front elements Ej+1 in the front layer Lj+1 and only part of the front elements Ej in the front layer Lj.

Next, in step S150, as shown in FIG. 4, the computing unit 150 computes the selected element (e.g., the selected element Ej+2) according to the at least one front computing data group (e.g., the front computing data group Gj+2). In this step, only part of the front elements Ej+1 in the front layer Lj+1 are stored and only part of the front elements Ej in the front layer Lj are stored.

Then, in step S160, as shown in FIG. 4, the determining unit 160 determines whether all of the chosen elements in the chosen layer (e.g., the chosen layer Lj+2) are selected and computed. If all of the chosen elements in the chosen layer are selected and computed, then the process proceeds to the step S170; if not all of the chosen elements in the chosen layer are selected and computed, then the process goes back the step S130. The step S130 of selecting the selected element and the step S150 of computing the selected element are performed repeatedly until all of the chosen elements in the chosen layer are selected and computed.

In step S170, the determining unit 160 determines whether all of the layers in the neural network are computed. If all of the layers in the neural network are computed, then the process terminated; if not all of the layers in the neural network are computed, then the process proceeds to step S110. The step S110 of deciding the chosen layer and the step S120 of deciding the front layers are performed repeatedly until all of the layers in the neural network are computed.

According to the neural network computing method, because only part of the front elements in any one of the front layers are needed to be stored, the memory usage is greatly reduced. Therefore, the memory area and the cost can be decreased. In some applications, such as speech recognition, the computation is not that timing-sensitive. The neural network computing method of the present embodiment is suitable for this application.

Not only the speech recognition application, some object detection applications might not require a high frame rate performance. For example, in the home security monitoring application, it only needs few frames per second to recognize the object and trigger the recording process. The neural network computing method of the present embodiment is suitable for this application.

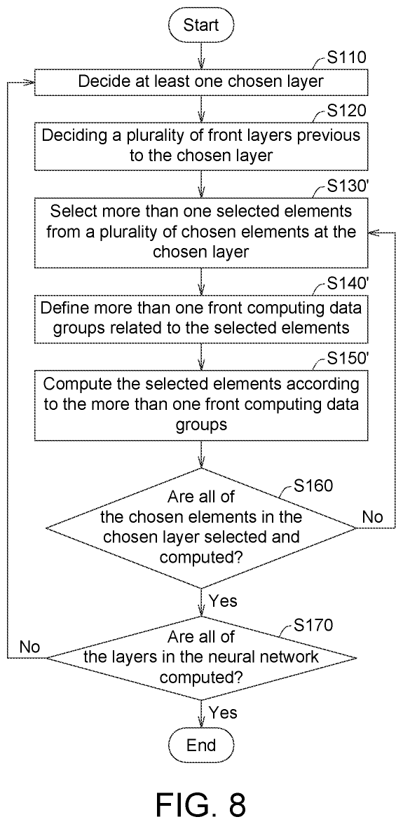

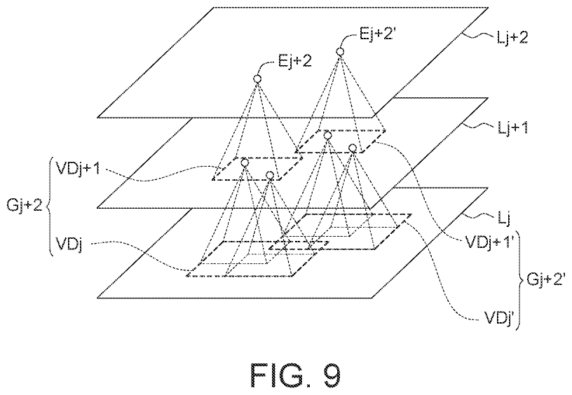

In the steps S130 to S150, only one selected element is computed at one time. In another embodiment, more than one selected elements could be computed in parallel. Please refer to FIG. 8, which shows a flowchart of a neural network computing method according to another embodiment. In step S130′, as shown in FIG. 9, the selecting unit 130 selects more than one selected elements (e.g., the selected elements Ej+2, Ej+2′) from a plurality of chosen elements in the chosen layer (e.g., the chosen layer Lj+2). FIG. 9, which illustrates front computing data of more than one selected elements. In this step, more than one chosen elements in the chosen layer (e.g., the chosen layer Lj+2) are selected to be the selected elements (e.g., the selected elements Ej+2, Ej+2′). After the selected elements Ej+2, Ej+2′ are computed, then some of the remained chosen elements are selected to be selected elements.

Afterwards, in step S140′, as shown in FIG. 9, the defining unit 140 defines more than one front computing data groups (e.g., the front computing data groups Gj+2, Gj+2′) related to the selected element (e.g., the selected elements Ej+2, Ej+2′). Each of the front computing data groups Gj+2, Gj+2′ is composed of only part of the front elements Ej+1 in the front layer Lj+1 and only part of the front elements Ej in the front layer Lj. The front computing data VDj+1, VDj of the front computing data group Gj+2 and the front computing data VDj+1′, VDj′ of the front computing data group Gj+2′ might be overlapped. The front computing data group Gj+2 and the front computing data group Gj+2′ could be stored in an identical memory, and the overlapped data could be stored at the same location.

Next, in step S150′, as shown in FIG. 9, the computing unit 150 computes the more than one selected elements (e.g., the selected element Ej+2, Ej+2′) according to the more than one front computing data groups (e.g., the front computing data groups Gj+2, Gj+2′). In this step, because the front computing data group Gj+2 and the front computing data group Gj+2′ are overlapped, the computation for the selected elements Ej+2, Ej+2′ could share some of the stored front elements in the front layers. Therefore, the computation performance can be improved.

According to the embodiments described above, the data in the neural network could be computed via front computing data, and only part of the front elements in any one of the front layers are needed to be stored. Therefore, the memory usage is greatly reduced, and the memory area as well as the cost can be decreased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A neural network computing method, comprising:
deciding at least one chosen layer;
deciding a plurality of front layers previous to the chosen layer;
selecting a selected element from a plurality of chosen elements in the chosen layer;
defining a front computing data group related to the selected element, wherein the front computing data group is composed of only part of a plurality of front elements in the front layers; and
computing the selected element according to the at least one front computing data group.

2. The neural network computing method according to claim 1, wherein a number of the front layers is more than two.

3. The neural network computing method according to claim 1, further comprising:
determining whether all of the chosen elements in the chosen layer are selected and computed;
wherein the step of selecting the selected element and the step of computing the selected element are performed repeatedly until all of the chosen elements in the chosen layer are selected and computed.

4. The neural network computing method according to claim 1, wherein a number of the at least one chosen layer is more than one.

5. The neural network computing method according to claim 1, wherein the neural network computing method is used for a Visual Geometry Group (VGG) model, a residual network (ResNET) model, or a Binary neural network model.

6. A neural network computing device, comprising:
a deciding unit, configured to decide at least one chosen layer and decide a plurality of front layers previous to the chosen layer;
a selecting unit, configured to select a selected element from a plurality of chosen elements in the chosen layer;
a defining unit, configured to define a front computing data group related to the selected element, wherein the front computing data group is composed of only part of a plurality of front elements in the front layers; and
a computing unit, configured to compute the selected element according to the at least one front computing data group.

7. The neural network computing device according to claim 6, wherein a number of the front layers is more than two.

8. The neural network computing device according to claim 6, further comprising:
a determining unit, configured to determine whether all of the chosen elements in the chosen layer are selected and computed;
wherein the selecting unit selects the selected element and the computing unit computes the selected element repeatedly until all of the chosen elements in the chosen layer are selected and computed.

9. The neural network computing device according to claim 6, wherein a number of the at least one chosen layer is more than one.

10. The neural network computing device according to claim 6, wherein the neural network computing device is used for a Visual Geometry Group (VGG) model, a residual network (ResNET) model, or a Binary neural network model.

11. A neural network computing method, comprising:
deciding at least one chosen layer;
deciding a plurality of front layers previous to the chosen layer;
selecting more than one selected elements from a plurality of chosen elements in the chosen layer;
defining more than one front computing data groups related to the selected elements, wherein each of the front computing data groups is composed of only part of a plurality of front elements in the front layers; and
computing the selected elements according to the more than one front computing data groups.

12. The neural network computing method according to claim 11, wherein a number of the front layers is more than two.

13. The neural network computing method according to claim 11, further comprising:
determining whether all of the chosen elements in the chosen layer are selected and computed;
wherein the step of selecting the selected elements and the step of computing the selected elements are performed repeatedly until all of the chosen elements in the chosen layer are selected and computed.

14. The neural network computing method according to claim 11, wherein a number of the at least one chosen layer is more than one.

15. The neural network computing method according to claim 11, wherein the neural network computing method is used for a Visual Geometry Group (VGG) model.

16. The neural network computing method according to claim 11, wherein the neural network computing method is used for a residual network (ResNET) model.

17. The neural network computing method according to claim 11, wherein the neural network computing method is used for a Binary neural network model.

18. The neural network computing method according to claim 13, wherein the selected elements are computed in parallel.

19. The neural network computing method according to claim 13, wherein the front computing data groups are stored in an identical memory.

20. The neural network computing method according to claim 13, wherein the front computing data groups are overlapped.
